(19) United States
(12) Patent Application Publication
(10) Pub. No.: US 2026/0185765 A1
(43) Pub. Date: Jul. 2, 2026

(54) COMPACT COOLER FOR FOOD PRODUCTS

(71) Applicant: Ronald Huff, New London, CT (US)

(72) Inventor: Ronald Huff, New London, CT (US)

(21) Appl. No.: 19/004,403

(22) Filed: Dec. 29, 2024

(51) Int. Cl. F25D 11/00; A23B 2/80; B01D 53/26; F25D 17/04

(52) U.S. Cl. CPC F25D 11/003; A23B 2/805; B01D 53/268; F25D 17/042; B01D 2257/80; B01D 2258/06; B01D 2259/4525; B01D 2259/4541; F25D 2317/0411

(57) ABSTRACT

A compact cooler for food products is disclosed, designed for countertop use to maintain freshness and desired consistency. The device utilizes a thermoelectric cooling system, employing semiconductors for efficient and environmentally friendly cooling, and an ionic membrane dehumidifier to lower humidity. The cooler maintains a temperature approximately 10-15 degrees Fahrenheit below ambient, ideal for preserving the spread-ability or mixability of food products. Features include removable and dishwasher-safe interior components, and a design optimized for energy efficiency and minimal maintenance. The invention provides a convenient and space-saving solution for storing food products at optimal conditions, enhancing their quality and lifespan.

### FIELD OF THE INVENTION

The present invention relates to compact, portable cooling devices for food storage.

### BACKGROUND OF THE INVENTION

Compact, portable coolers are known and particularly useful for storing small food products and other situations where one desires to maintain food or beverages at a cool temperature without the need for a built-in or full-size refrigerator in a home or office.

Compact, portable coolers are also useful in a home or office for providing convenient storage for cooling beverages or foods in areas other than the kitchen or in otherwise supplementing a full-size kitchen refrigerator. These devices offer a convenient solution for maintaining optimal storage conditions for temperature-sensitive items.

### BRIEF DESCRIPTION OF THE DRAWINGS

FIG. 1 is a front elevation view of the invention;

FIG. 2 is a bottom plan view thereof;

FIG. 3 is a top plan view thereof,

FIG. 4 is a left side elevational view thereof;

FIG. 5 is a right side elevational view thereof;

FIG. 6 is an isometric bottom left view thereof, and,

FIG. 7 is an isometric bottom right view thereof; and,

FIG. 8 is an isometric top left view thereof, and,

FIG. 9 is an isometric top right view thereof; and,

FIG. 10 is a perspective view photograph showing a conceptual lid covering the butter dish portion; and,

FIG. 11 is a perspective view photograph thereof.

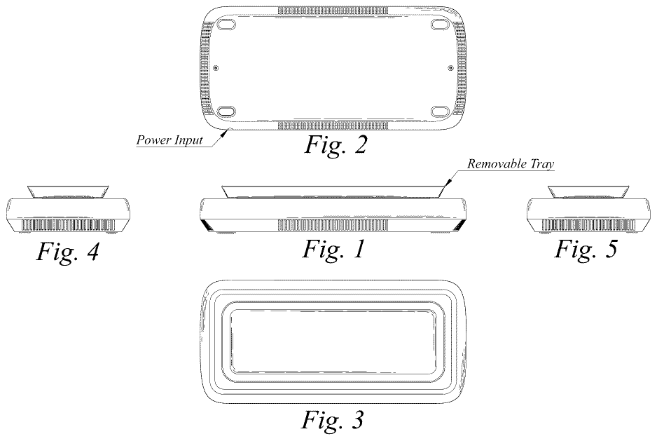

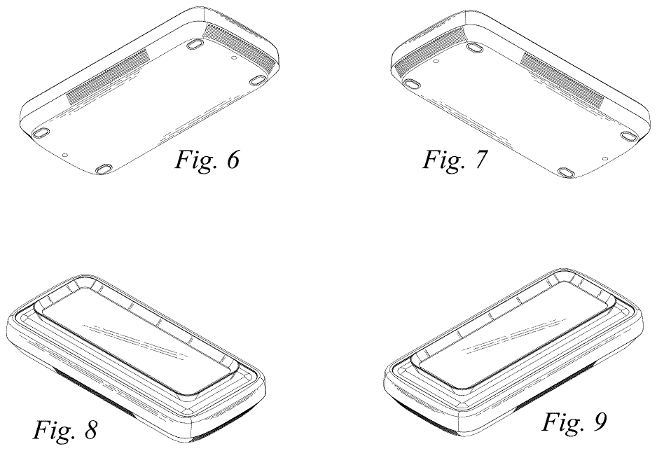

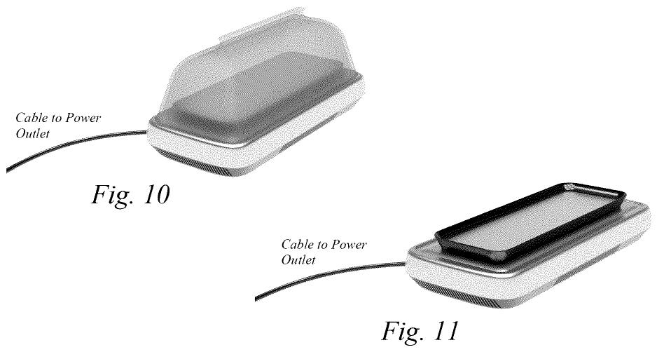

### DESCRIPTION OF THE INVENTION

The optimal storage temperature and duration for food products is a common topic of debate and often depends on personal preference. Certainly, many persons appreciate the convenience of keeping food products readily at hand on a kitchen counter-top, and often at higher temperatures than are common in a cooler for softer products that are easier and faster to spread and use in baking. However, it is also understood that food products left on a kitchen countertop at room temperature have a shorter period of freshness than those kept in a kitchen refrigerator.

Food products are commonly used food items that require proper storage to maintain their flavor and freshness. Traditional coolers often have temperature fluctuations that can cause the products to become too hard or too soft, resulting in decreased quality and taste. Moreover, variations in humidity levels within conventional coolers can further compromise the quality of stored food products. The cooler of the present invention, specifically designed for food product storage, can solve these problems. The present invention also includes an ionic membrane dehumidifier to reduce and maintain the relative humidity at an optimal level, to enhance the freshness of the food products.

The present invention provides a cooler that can hold and keep food products at a reduced temperature of about 10 degrees below ambient for keeping the food product at a desired softness for eating, cooking or baking, such as, for example, a temperature for imparting to the food product a desired consistency or softness for spread-ability or for mixing with other food ingredients during food preparation.

The cooler of the invention is sized for easily fitting on a countertop or dining table for keeping the food products conveniently ready-at-hand, without need for opening a full-size kitchen cooler, thereby saving more than enough energy to compensate for any additional energy the cooler might use.

Such cooler of the invention is sized to contain about one or more standard size portion of a food product, optionally contained within a standard size dish. The cooler could contain various quantities of food products but often the smallest size is preferred for taking up less space and for holding enough product for most typical daily needs.

The cooler of the invention preferably has adjustable shelves, allowing users to store different sizes and shapes of containers for food products. Further, at least the interior portions of the cooler that may be in contact with food products are washable, and preferably are removable for washing in a dishwasher.

In one embodiment, preferred coolers of the invention work without any liquid refrigerants (which can be harmful to the environment), motors (which can be noisy), or condensation (which can be messy). Such preferred coolers of the invention employ semiconductors in the environmentally friendly Peltier semiconductor system, coupled with an ionic membrane dehumidifier, which affords substantial flexibility in shape and size, more than has been common with conventional coolers. The ionic membrane dehumidifier is used to actively remove moisture from the air, maintaining a reduced humidity level below ambient inside the cooler compartment.

This cooler will typically have a cooling fan; and for best results, a clearance between any surfaces and the cooler's cooling fan should preferably be maintained. The cooler can have a lid, or hinged door and if desired a locking mechanism or latch.

The cooler of the invention, by using a thermoelectric cooling system, is quite efficient and may use less electricity than a compressor-based unit of the same size.

In at least one embodiment, the food product compartment includes a removable tray that can be easily removed for cleaning or filling. The tray is designed to hold one or more portions of food products and can have a non-stick surface that prevents the product from sticking to the tray. The tray is also equipped with or without a handle for easy removal and insertion into the cooler.

The three figures show an embodiment of the cooler of the invention shaped like a dish, with a tray and a lid. In this embodiment, the tray is chilled (from the base of the cooler). The lid, or the enclosure about the tray, can also be directly or indirectly chilled or cooled. The tray can be removable for cleaning and also for holding the food product for use if desired. The tray can also be washable in a dishwasher and in one embodiment at least a portion of the enclosure, such as the lid as shown, can be removable and washable in a dishwasher as well. The lid can be transparent, translucent or opaque.

The cooler designed specifically for food product storage is powered by a standard electrical outlet.

Another significant benefit of a cooler with a thermoelectric cooling system is that such system has no moving parts and therefore less mechanical wear which results in reduced instances of failure due to fatigue and fracture from mechanical vibration and stress, which in turn increases the lifespan of the system and lowers maintenance requirements. The inclusion of an ionic membrane dehumidifier further enhances the system's reliability by preventing moisture buildup, which could otherwise lead to corrosion or electrical shorts.

While the present invention is described as a cooler, the cooler of the invention can be used for keeping other small items cool and fresh, such as medicine or other items. Such utility can be appreciated in dorm rooms, offices, and small homes and campers.

1. A miniature cooler sized to contain at least one portion of a food product within a container on a counter-top.

2. The miniature cooler of claim 1 having a thermoelectric cooling system.

3. The miniature cooler of claim 2 having an ionic membrane dehumidifier.

4. A method of storing a food product on a counter-top while maintaining freshness and a desired level of softness by storing said food product on said counter-top in a miniature cooler, said cooler further comprising a dehumidifier to maintain a lower than ambient relative humidity.

5. The method of claim 4 wherein said miniature cooler has a thermoelectric cooling system.

6. The method of claim 5 wherein said miniature cooler has an ionic membrane dehumidifier.

7. The method of claim 6 wherein said miniature cooler has semiconductors.

8. The method of claim 7 wherein portions of said interior that have contact with food can be removed for washing in a dishwasher.
